(19) United States
(12) Patent Application Publication
(10) Pub. No.: US 2007/0206106 A1
(43) Pub. Date: Sep. 6, 2007

(54) Image capturing unit

(75) Inventors: Tomokazu Kakumoto, Yokohama-shi (JP); Masayuki Kusuda, Akashi-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/710,124

(22) Filed: Feb. 23, 2007

(30) Foreign Application Priority Data
Mar. 1, 2006 (JP) 2006-054705

(51) Int. Cl. H04N 5/335

(52) U.S. Cl. 348/308

(57) ABSTRACT

There is described an image capturing unit, which make it possible to prevent occurrence of noses, such as lateral stripes, etc., in the captured image, even if a vertical blanking period is introduced. The unit includes: an image sensor provided with pixels aligned in a two-dimensional matrix pattern, a first vertical scanning circuit and a second vertical scanning circuit, to conduct a line progressive scanning; and a control circuit to control a scanning operation of the image sensor. The image sensor is further provided with a dummy pixel area, and the control circuit controls the scanning operation of the image sensor in such a manner that, when any one of the first vertical scanning circuit and the second vertical scanning circuit enters in a vertical blanking period, the concerned one of the first vertical scanning circuit and the second vertical scanning circuit scans the dummy pixel area.

This application is based on Japanese Patent Application No. 2006-054705 filed on Mar. 1, 2006 in Japanese Patent Office, the entire content of which is hereby incorporated by reference.

### BACKGROUND OF THE INVENTION

The present invention relates to an image capturing unit, and specifically relates to an image capturing unit that is provided with an image sensor in which two vertical scanning circuits are provided and a progressive scanning method is employed for capturing an image.

In a conventional image capturing unit provided with an image sensor, either an interrace scanning method or the progressive scanning method (namely, a non-interrace scanning method) is employed for conducting the image capturing operation, and generally speaking, an image capturing time interval is limited to one field time period ( 1/60 second) or one frame time period ( 1/30 second). Accordingly, in order to capture an optimum image corresponding to the brightness of the subject, it is necessary in most of the cases to vary an aperture mounted in an optical system, and for this purpose, an expensive lens system provided with an aperture control mechanism is required for such the image capturing unit. It is inadequate, however, to employ such the expensive lens system, having the aperture control mechanism, for a low-cost camera, such as a surveillance camera, etc. Further, there has been a problem that the aperture control mechanism is liable to fail frequently, and its liability is low.

To overcome the abovementioned problem, for instance, Patent Document 1 (Tokkouhei 4-31626, Japanese Examined Patent Publication) sets forth a method for obtaining an optimum image corresponding to the brightness of the subject without employing the aperture control mechanism. According to the method set forth in Patent Document 1, the image capturing unit is provided with two vertical scanning circuits, one of which is used for reading electronic charges representing image signals (hereinafter, referred to as signal charges, for simplicity) and another one of which is used for ejecting unnecessary electronic charges, so that, prior to the reading operation of the signal charges, the electronic charges are ejected as the unnecessary electronic charges, so as to vary the storage time of the signal charges.

On the other hand, due to the difference in standards between the conventional image sensor and the typical displaying apparatus, the effective horizontal line number of the typical image sensor (for instance, 480 lines for the VGA image sensor) does not necessary coincide with that of the typical displaying apparatus (for instance, 525 lines for the NTSC television monitor). Accordingly, to synchronize the vertical scanning of the image sensor with that of the displaying apparatus, the vertical blanking period, namely, a waiting period for establishing a synchronization between them, is typically introduced in the vertical scanning period of the image sensor (for instance, when establishing a synchronization between the VGA image sensor and the NTSC television monitor, 525−480=45 horizontal lines).

However, in the abovementioned method in which the vertical blanking period is introduced as set forth in Patent Document 1 (Tokkouhei 4-31626, Japanese Examined Patent Publication), both the scanning circuit used for reading the signal charges and the other scanning circuit used for ejecting the unnecessary electronic charges simultaneously scan two different horizontal pixel lines during the time when both are scanning the effective pixel area, while, during the time when any one of the scanning circuit used for reading the signal charges and the other scanning circuit used for ejecting the unnecessary electronic charges is entering in the vertical blanking period, only one horizontal pixel lines is virtually scanned by a scanning circuit which is not entering the vertical blanking period, since no horizontal pixel line to be scanned by a scanning circuit, which is currently entering the vertical blanking period, exists in the vertical blanking period.

In such a case as mentioned in the above, the load incurred to the analogue electric power source, which supplies the electric voltage for driving the pixels according to the signals inputted into the scanning circuit used for reading the signal charges and the other scanning circuit used for ejecting the unnecessary electronic charges, varies depending on a number of horizontal pixel lines. This would cause errors in various kinds of electric potentials to be supplied to each of the pixels, and such the errors result in occurrence of noses, such as lateral stripes, etc., as a deficiency in the photographed image.

To overcome the abovementioned problems, it may be considered that a number of effective horizontal pixel lines of the image sensor is matched with a number of the scanning lines of the displaying apparatus so as to make it possible to eliminate the vertical blanking period. However, a number of the scanning lines of the displaying apparatus varies with the television standards, for instance, 525 lines in the NTSC standard while 625 lines in the PAL standard. Further, since there exist various kinds of standards in the field of the PC monitor (personal computer use), it is very cumbersome and ineffective to provide an exclusive image sensor for every standard of various displaying apparatus.

### SUMMARY OF THE INVENTION

To overcome the abovementioned drawbacks in conventional image capturing unit, it is an object of the present invention to provide an image capturing unit, which is provided with an image sensor including two vertical scanning circuits used for reading the signal charges and used for ejecting the unnecessary electronic charges, so as to make it possible to prevent occurrence of noses, such as lateral stripes, etc., in the captured image, even if a vertical blanking period is introduced.

Accordingly, to overcome the cited shortcomings, the abovementioned object of the present invention can be attained by image capturing units and methods described as follow.

(1) An image capturing unit, comprising: an image sensor that is provided with a plurality of pixels, aligned in a two-dimensional matrix pattern, to capture an image of a subject, a first vertical scanning circuit and a second vertical scanning circuit, to conduct a line progressive scanning; and a control circuit to control a scanning operation of the image sensor; wherein the image sensor is further provided with a dummy pixel area, and the control circuit controls the scanning operation of the image sensor in such a manner that, when any one of the first vertical scanning circuit and the second vertical scanning circuit enters in a vertical blanking period, the concerned one of the first vertical scanning circuit and the second vertical scanning circuit scans the dummy pixel area.

(2) The image capturing unit of item 1, wherein the dummy pixel area is fabricated onto at least one of an upper side portion and a lower side portion of the two-dimensional matrix pattern.

(3) The image capturing unit of item 1, wherein, when any one of the first vertical scanning circuit and the second vertical scanning circuit enters in the vertical blanking period, the control circuit halts an operation for supplying scanning pulses, a number of which is equivalent to {(a number of scanning lines included in the vertical blanking period)−1}, to the concerned one of the first vertical scanning circuit and the second vertical scanning circuit.

(4) The image capturing unit of item 1, wherein the image sensor is further provided with a vertical scanning drive circuit to drive the plurality of pixels by supplying an analogue voltage.

(5) The image capturing unit of item 4, wherein the vertical scanning drive circuit applies a predetermined voltage onto a gate of a transferring transistor included in each of the plurality of pixels, during an image capturing operation of the plurality of pixels.

(6) The image capturing unit of item 4, wherein the vertical scanning drive circuit applies a predetermined voltage onto a gate of a resetting transistor included in each of the plurality of pixels, during an image capturing operation of the plurality of pixels.

(7) An image capturing unit, comprising: an image sensor that is provided with a plurality of pixels, aligned in a two-dimensional matrix pattern, to capture an image of a subject, a first vertical scanning circuit and a second vertical scanning circuit, to conduct a line progressive scanning operation; and a control circuit to control a scanning operation of the image sensor; wherein, even if a vertical blanking period exists in the line progressive scanning operation, the control circuit controls the scanning operation of the image sensor in such a manner that any one of the first vertical scanning circuit and the second vertical scanning circuit is made to scan a specific horizontal pixel line including elements, which are not to be used for forming a reproduced image of the image, at a predetermined timing, so that a pair of the first vertical scanning circuit and the second vertical scanning circuit always scans two horizontal pixel lines residing in the two-dimensional matrix pattern, respectively.

(8) The image capturing unit of item 7, wherein the predetermined timing is defined as a time when any one of the first vertical scanning circuit and the second vertical scanning circuit is made to scan a horizontal pixel line, which is currently used for capturing the image, while another one of them need not scan any horizontal pixel line used for capturing the image.

(9) The image capturing unit of item 7, wherein the predetermined timing is defined as a time period residing between a frame and a next frame, in which any one of the first vertical scanning circuit and the second vertical scanning circuit is made to scan a horizontal pixel line, which is currently used for capturing the image, while another one of them is waiting in a standby state until the other one of them commences to scan a horizontal pixel line used for capturing the image.

(10) The image capturing unit of item 7, wherein, when any one of the first vertical scanning circuit and the second vertical scanning circuit enters in the vertical blanking period, the control circuit halts an operation for supplying scanning pulses, a number of which is equivalent to {(a number of scanning lines included in the vertical blanking period)−1}, to the concerned one of the first vertical scanning circuit and the second vertical scanning circuit.

(11) The image capturing unit of item 7, wherein each of the elements, which are not to be used for forming the reproduced image of the image, serves as a electric load having substantially a same property as that of each of the plurality of pixels.

(12) The image capturing unit of item 7, wherein the elements, which are not to be used for forming the reproduced image of the image, are dummy pixels.

(13) The image capturing unit of item 12, wherein the dummy pixels are fabricated onto at least one of an upper side portion and a lower side portion of the two-dimensional matrix pattern.

(14) The image capturing unit of item 7, wherein a configuration of each of the elements, which are not to be used for forming the reproduced image of the image, is substantially a same as that of each of the plurality of pixels.

(15) A method for capturing an image, comprising: capturing an image of a subject by employing an image sensor that is provided with a plurality of pixels, aligned in a two-dimensional matrix pattern, a first vertical scanning circuit and a second vertical scanning circuit, to conduct a line progressive scanning operation; and controlling a scanning operation of the image sensor; wherein, even if a vertical blanking period exists in the line progressive scanning operation, the scanning operation of the image sensor is controlled in such a manner that any one of the first vertical scanning circuit and the second vertical scanning circuit is made to scan a specific horizontal pixel line including elements, which are not to be used for forming a reproduced image of the image, at a predetermined timing, so that a pair of the first vertical scanning circuit and the second vertical scanning circuit always scans two horizontal pixel lines residing in the two-dimensional matrix pattern, respectively.

(16) The method of item 15, wherein the predetermined timing is defined as a time when any one of the first vertical scanning circuit and the second vertical scanning circuit is made to scan a horizontal pixel line, which is currently used for capturing the image, while another one of them need not scan any horizontal pixel line used for capturing the image.

(17) The method of item 15, wherein the predetermined timing is defined as a time period residing between a frame and a next frame, in which any one of the first vertical scanning circuit and the second vertical scanning circuit is made to scan a horizontal pixel line, which is currently used for capturing the image, while another one of them is waiting in a standby state until the other one of them commences to scan a horizontal pixel line used for capturing the image.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a block diagram of an exemplified internal configuration of an image sensor employed in an image capturing unit embodied in the present invention;

FIG. 2 shows an exemplified circuit diagram of each pixel included in a plurality of pixels constituting an image sensor;

FIG. 3 shows an exemplified circuit diagram indicating a configuration of a vertical scanning drive circuit and peripheral circuits;

FIG. 4 shows an exemplified circuit diagram of an internal configuration of a first vertical scanning circuit;

FIG. 5 shows a timing chart of operations of a shift register shown in FIG. 4;

FIG. 6 shows a schematic diagram of scanning statuses of horizontal pixel lines when no vertical blanking period is introduced;

FIG. 7 shows another schematic diagram of scanning statuses of horizontal pixel lines when a vertical blanking period is introduced;

FIG. 8 shows a schematic diagram of scanning statuses of horizontal pixel lines in a method for preventing a variation of a load to be driven by a vertical scanning drive circuit;

FIG. 9 shows a timing chart indicating scanning statuses of the configuration shown in FIG. 8;

FIG. 10 shows a schematic diagram of scanning statuses of horizontal pixel lines in the method for realizing a shutter operation of long duration, which exceeds one frame period; and

FIG. 11 shows a timing chart indicating scanning statuses of the configuration shown in FIG. 10.

### DETAILED DESCRIPTION OF THE PREFERRED EMBODIMENT

Referring to the drawings, the embodiment of the present invention will be detailed in the following. Incidentally, the same reference number will be attached to the same or similar elements in the drawing, and the duplicated explanation will be omitted.

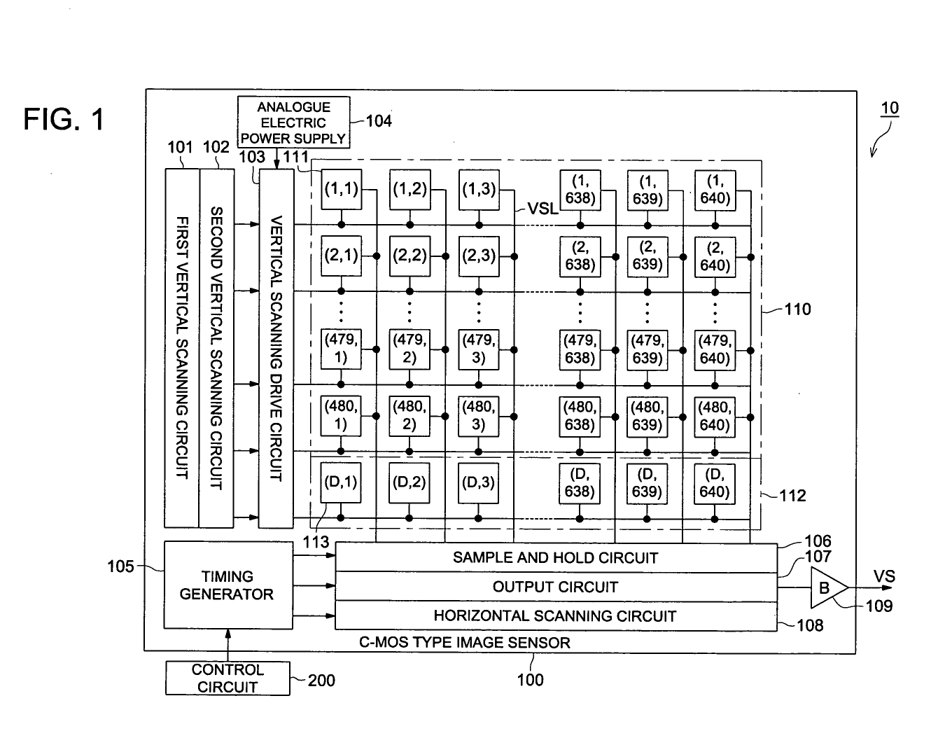

Initially, referring to FIG. 1 through FIG. 5, an image capturing unit embodied in the present invention will be detailed in the following.

FIG. 1 shows a block diagram of an exemplified internal configuration of an image sensor employed in the image capturing unit. An image capturing unit 10 is constituted by an image sensor 100, a control circuit 200, etc. The image sensor 100 is a CMOS-type image sensor constituted by a first vertical scanning circuit 101, a second vertical scanning circuit 102, a vertical scanning drive circuit 103, an analogue electric power supply 104, a timing generator 105, a sample and hold circuit 106, an output circuit 107, a horizontal scanning circuit 108, an output buffer circuit 109, an effective pixel area 110, a dummy pixel area 112, etc.

Although the timing generator 105 is incorporated in the image sensor 100 in the block diagram shown in FIG. 1, it is also applicable that the timing generator 105 is disposed outside the image sensor 100, or a part of the timing generator 105 is disposed inside while another part is disposed outside.

The effective pixel area 110 includes a plurality of pixels 111, and, in this example, the pixels from a pixel (1, 1) to a pixel (480, 640) are arranged in a lattice pattern constituted by 480 horizontal lines and 640 vertical columns. It is needless to say that the number of horizontal lines and a number of vertical columns are not limited to the above. Further, the arranging pattern is not limited to the lattice pattern, and a honeycomb structure in which hexagon pixels are densely arranged is also applicable. Incidentally, to make the following explanation simple, a pixel area of the effective pixel area 110, located at a side of the line from the pixel (1, 1) to a pixel (1, 640) is called an upper section of the image sensor 100, while, another pixel area of the effective pixel area 110, located at a side of the line from a pixel (480, 1) to the pixel (480, 640) is called an lower section of the effective pixel area 110.

The dummy pixel area 112 is constituted by a plurality of dummy pixels 113, and, in this example, 640 dummy pixels from a pixel (D, 1) to a pixel (D, 640) are arranged in a line at the lower section of the effective pixel area 110. However, the scope of the present invention is not limited to the above. It is also applicable that the plurality of dummy pixels 113 are disposed at the upper side of the effective pixel area 110 or both the upper and lower sides of the effective pixel area 110. Further, the structure of each of the plurality of dummy pixels 113 is not necessary the same as that of the plurality of pixels 111. It is applicable that each of the plurality of dummy pixels 113 is an element being equivalent to each of the plurality of pixels 111 as the electrical load.

Further, each of the plurality of dummy pixels is not necessary only serving as default dummy pixels. Concretely speaking, even if the plurality of pixels included in the image sensor are the same as each other in its elemental configuration, it is applicable that a specific pixel, which is not employed as a photo-sensing element for forming the captured image during the image capturing operation, is made to serve as a dummy pixel. In this case, although the physical configuration of the specific pixel is the same as those of the other pixels employed as the photo-sensing element, the specific pixel could be made to serve as the dummy pixel corresponding to a manner for driving the specific pixel during the image capturing operation.

The plurality of pixels 111 and the plurality of dummy pixels 113 are driven by the vertical scanning drive circuit 103, according to the signals outputted by the first vertical scanning circuit 101 and the second vertical scanning circuit 102 and various kinds of electric potentials fed from the analogue electric power supply 104. Pixel outputs VOUT of the plurality of pixels 111 are outputted onto a vertical signal line VSL and once stored in the sample and hold circuit 106, and then, according to the horizontal scanning operation conducted by the horizontal scanning circuit 108, outputted outside the image sensor 100 as an image output signal VS through the output circuit 107 and the output buffer circuit 109. Each of the operations mentioned in the above is controlled by the timing generator 105 under the controlling actions of the control circuit 200. The control circuit 200 and the timing generator 105 serve as a scanning control circuit embodied in the present invention.

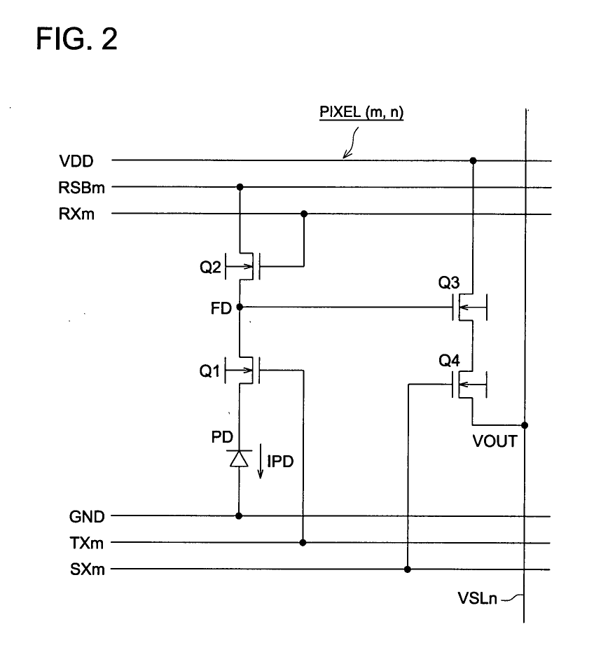

FIG. 2 shows an exemplified circuit diagram of each pixel included in the plurality of pixels 111 constituting the image sensor 100. In FIG. 2, a pixel (m, n) located at an intersection of m-th line and n-th column in the effective pixel area is exemplified. The pixel (m, n) is constituted by an implanted photodiode PD, serving as a photoelectronic converting section (hereinafter, referred to as a PD section) and four N-channel MOSFETs Q1, Q2, Q3, Q4 (N-channel Metal Oxide Semiconductor Field Effect Transistor: hereinafter, referred to as transistors Q1, Q2, Q3, Q4, for simplicity). A floating diffusion FD (hereinafter, referred to as a FD section) is structured at a connecting point of a drain of the transistor Q1 and a source of the transistor Q2.

The signals (electric potentials) to be applied to the transistors in each of the plurality of pixels 111 include a reset voltage RSBm serving as an analogue voltage to be supplied to the plurality of pixels 111 from the vertical scanning drive circuit 103, a reset signal RXm, a transferring signal TXm and a readout signal SXm being digital signals, while symbols VDD and GND indicate a electric power voltage and a ground, respectively.

The PD section serves as the photoelectronic converting section to generate a photoelectronic current Ipd corresponding to an amount of light coming from the subject. The photoelectronic current Ipd is stored in a parasitic capacitance Cpd and serves as a signal charge Qpd. Since the PD section is structured in an implanted type, and therefore, the photoelectronic current Ipd converted from the incoming light cannot be directly taken out, the PD section is coupled to the FD section through the transistor Q1 serving as a charge transferring device.

During the image capturing operation, the transferring signal TXm is set at an intermediate electric potential VTXM. Provided that symbol Vth indicates a threshold voltage of the transistor Q1, until an electric potential Vpd of the PD section reaches a value derived from a calculation of VTXM−Vth, the signal charge Qpd is accumulated into the parasitic capacitance Cpd of the PD section (a linear photoelectronic conversion characteristic). When the electric potential Vpd of the PD section exceeds the value of (VTXM−Vth), the current-to-voltage conversion is conducted according to the sub-threshold characteristic of the transferring transistor Q1, so that an electric charge derived by applying a logarithmic compression to the signal charge Qpd is accumulated into the parasitic capacitance Cpd of the PD section (a logarithmic photoelectronic conversion characteristic). Accordingly, when the photoelectronic current Ipd is small, namely, the subject is darkish, the photoelectronic converting action is conducted according to the linear photoelectronic conversion characteristic, while, when the photoelectronic current Ipd is great, namely, the subject is bright, the photoelectronic converting action is conducted according to the logarithmic photoelectronic conversion characteristic.

The reset transistor Q2, serving as a resetting device for resetting the FD section, is controlled by the reset signal RXm. When the reset transistor Q2 is turned ON, a voltage of the FD section is reset to a reset electric potential RSB.

The transistor Q3 serves as a source follower current-amplifying circuit, so as to lower an output impedance of an electric potential Vfd of the FD section by conducting a current amplifying action based on the electric potential Vfd coupled to its gate.

The transistor Q4 is a readout transistor for reading out a pixel output VOUT, which serves as a switching element that turns ON and OFF corresponding to a readout signal SXm. Since the source of the transistor Q4 is coupled to a vertical signal line VSLn, when the transistor Q4 turns ON, the electric potential Vfd of the FD section, the impedance of which is lowered by the transistor Q3, is outputted onto the vertical signal line VSLn as the pixel output VOUT.

As mentioned in the foregoing, in the example shown in FIG. 2, by controlling the gate voltage of the transferring transistor Q1 to the intermediate electric potential VTXM of a transferring signal TX during the image capturing operation and switching the linear and logarithmic photoelectronic conversion characteristics to each other, it is possible to conduct an image capturing operation in a wide dynamic range. Further, by limiting the action of the transferring transistor Q1 to only conventional ON/OF actions, it is also possible to employ the image sensor as a conventional image sensor of general purpose, which works only in the linear characteristic.

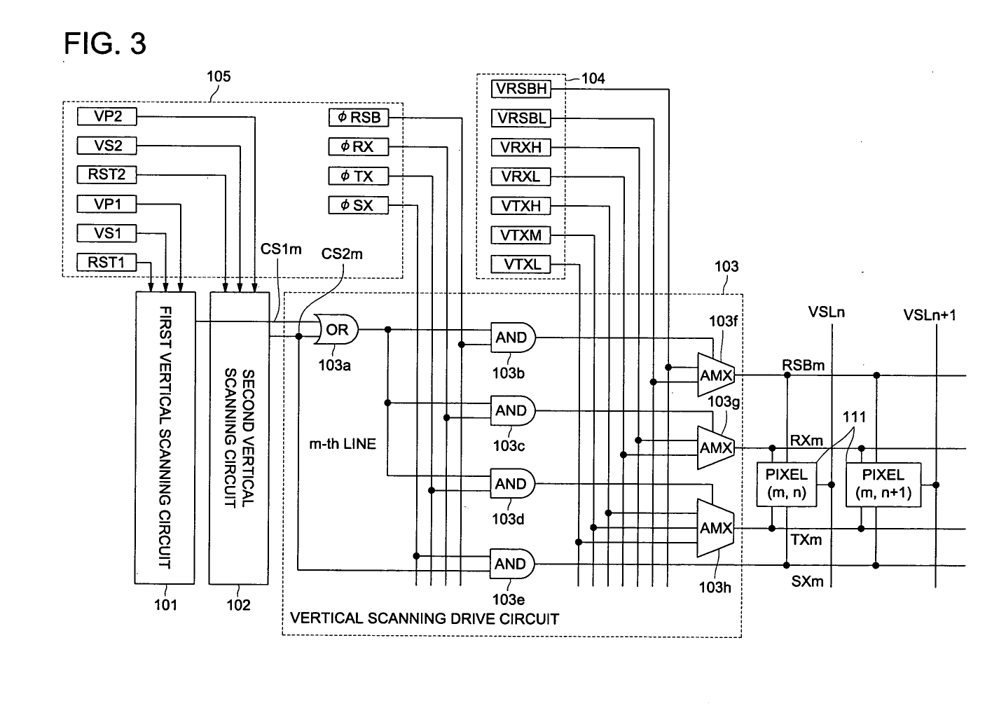

FIG. 3 shows an exemplified circuit diagram indicating a configuration of the vertical scanning drive circuit 103 and peripheral circuits. With respect to the vertical scanning drive circuit 103, only a portion for controlling the horizontal m-th pixel line is exemplified. In the whole circuit, the circuits, each of which is equivalent to the abovementioned portion shown in FIG. 3 and a number of which is equal to the total number of horizontal pixel lines residing in both the effective pixel area and the dummy pixel area, are aligned in parallel.

In FIG. 3, the first vertical scanning circuit 101 is controlled by a reset signal RST1, a start signal VS1 and a scanning pulse VP1, which are sent from the timing generator 105, so as to output a first select signal CS1m for selecting the horizontal m-th pixel line. As well as the first vertical scanning circuit 101, the second vertical scanning circuit 102 is also controlled by a reset signal RST2, a start signal VS2 and a scanning pulse VP2, which are sent from the timing generator 105, so as to output a second select signal CS2m for selecting the horizontal m-th pixel line.

Both the first select signal CS1m and the second select signal CS2m are inputted into an OR circuit 103a, and an output signal of the OR circuit 103a is inputted into input terminals of AND circuits 103b, 103c, 103d, while a reset voltage control signal ØRSB, a reset control signal ØRX and a transferring control signal ØTX, which are sent from the timing generator 105, are coupled to other input terminals of the AND circuits 103b, 103c, 103d. The second select signal CS2m is also coupled to an input terminal of an AND circuit 103e, while a readout control signal ØSX sent from the timing generator 105 is coupled to another input terminal of the AND circuit 103e.

The output signals of the AND circuits 103b, 103c, 103d are coupled to control terminals of analogue multiplexers 103f, 103g, 103h (hereinafter, referred to as AMX 103f, 103g, 103h). Further, a reset voltage H (VRSBH) and a reset voltage L (VRSBL) are inputted into the AMX 103f, so that either the VRSBH or the VRSBL is selected according to the output signal of the AND circuit 103b, and AMX 103f outputs the selected one as the reset voltage RSBm of the horizontal m-th pixel line.

As well as the above, in the AMX 103g, either a reset signal H (VRXH) or a reset signal L (VRXL), which is generated in the analogue electric power supply 104, is selected according to the output signal of the AND circuit 103c, and AMX 103g outputs the selected one as the reset signal RXm of the horizontal m-th pixel line. Further, in the AMX 103h, any one of a transferring signal H (VTXH), a transferring signal M (VTXM) and a transferring signal L (VTXL) is selected according to the output signal of the AND circuit 103d, and AMX 103h outputs the selected one as the transferring signal TXm of the horizontal m-th pixel line.

Incidentally, when the wide range image capturing operation is conducted by controlling the gate voltage of the reset transistor Q2 as aforementioned referring to FIG. 2, the three signals of the reset signal H (VRXH), the reset signal M (VRXM) and the reset signal L (VRXL) are inputted into the AMX 103g, and the two signals of the transferring signal H (VTXH) and the transferring signal L (VTXL) are inputted into the AMX 103h.

The AND circuit 103e outputs the readout signal SXm. The reset voltage RSBm, the reset signal RXm, the transferring signal TXm and the readout signal SXm are inputted to each of the pixels 111 residing on the horizontal m-th pixel line (the pixel (m, n) and the pixel (m, n+1) are exemplified in FIG. 3). According to the readout signal SXm, each of the pixels outputs the output signal onto the vertical signal line VSL (the vertical signal line VSLn and the vertical signal line VSLn+1 are exemplified in FIG. 3).

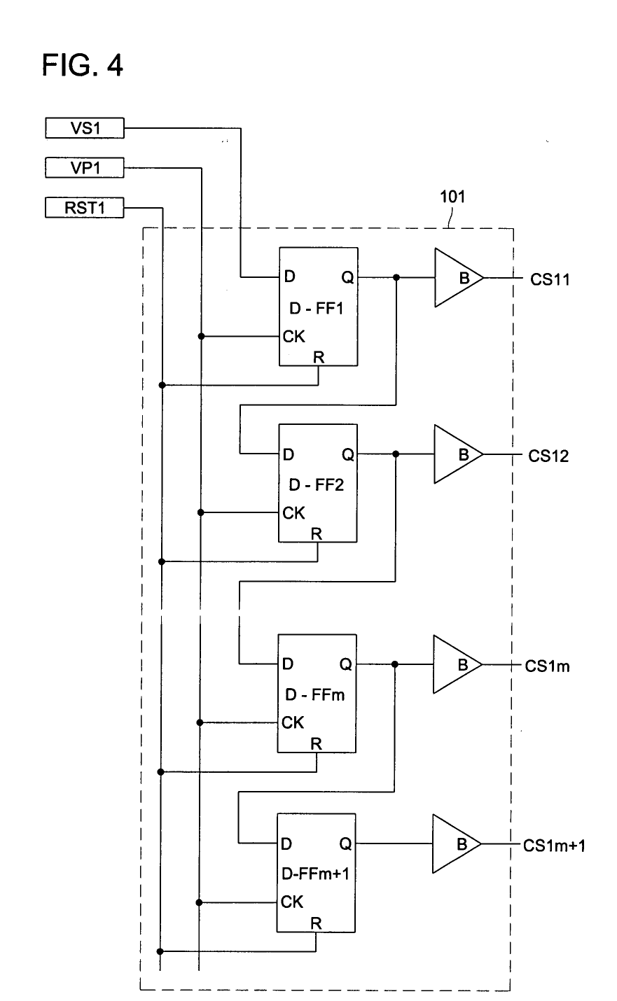

FIG. 4 shows an exemplified circuit diagram of the internal configuration of the first vertical scanning circuit 101 shown in FIG. 1 and FIG. 3. Since the internal configuration of the second vertical scanning circuit 102 is completely the same as that of the first vertical scanning circuit 101, only the internal configuration of the first vertical scanning circuit 101 will be detailed in the following.

In FIG. 4, the first vertical scanning circuit 101 is constituted by a plurality of D-type flip-flop circuits (hereinafter, referred to as a D-FF of D-FFs, for simplicity), a number of which is equal to the number of pixel columns of the image sensor 100. The start signal VS1 generated in the timing generator 105 is coupled to a D-input terminal of a first stage D-FF (D-FF1), while the scanning pulse VP1 and the reset signal RST1 are coupled to clock terminals CK and reset terminals R of the D-FFs, respectively. The reset signal RST1 is utilized for initializing the D-FFs at the time of turning ON the electric power, or at the time of system reset.

A noninverting output Q of the first stage D-FF (D-FF1) is coupled to a D-input terminal of a second stage D-FF and outputted though a buffer B as a first select signal CS11. As well as the above, a noninverting output Q of each of the D-FFs is coupled to a D-input terminal of a next stage D-FF and outputted though a buffer B as a first select signal CS1m.

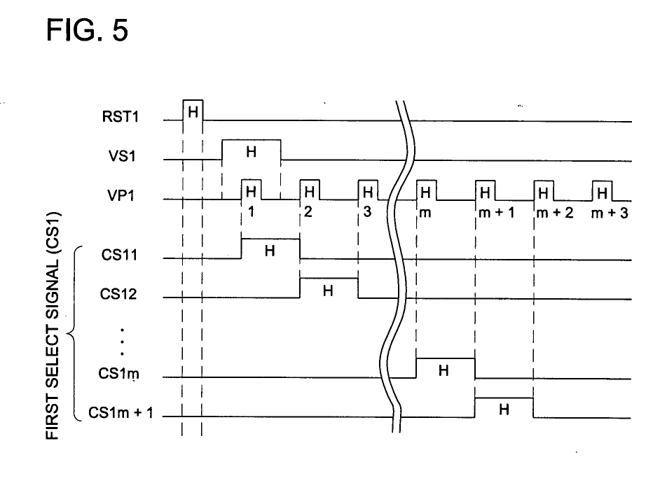

FIG. 5 shows a timing chart of the operations of the shift register shown in FIG. 4. In FIG. 5, when the electric power is turned ON, the reset signal RST1 generated by the timing generator 105 is maintained at high level H for a predetermined period, so as to initialize all of the D-FFs. Next, the start signal VS1 generated by the timing generator 105 is set to high level H. While the start signal VS1 is maintained at high level H, the scanning pulse VP1 is set to high level H, so as to maintain the noninverting output Q of the first stage D-FF (D-FF1), namely, the first select signal CS11, at high level H. Then, after the scanning pulse VP1 is returned to low level L, the start signal VS1 is also returned to low level L.

Next, the scanning pulse VP1 is set to high level H, so as to progress the shift register for one stage, namely, the first select signal CS11 is returned to low level L, and at the same time, the first select signal CS12 is maintained at high level H. As well as the above, according to the input timing of the scanning pulses VP1, the counting action of the shift register progresses one stage by one stage, so that, at the m-th pulse of the scanning pulses VP1, the first select signal CS1m for selecting the horizontal m-th pixel line is set to high level H. When the counting action of the shift register progresses to the final stage, the start signal VS1 is again set to high level H, in order to repeat the operations mentioned in the above thereafter.

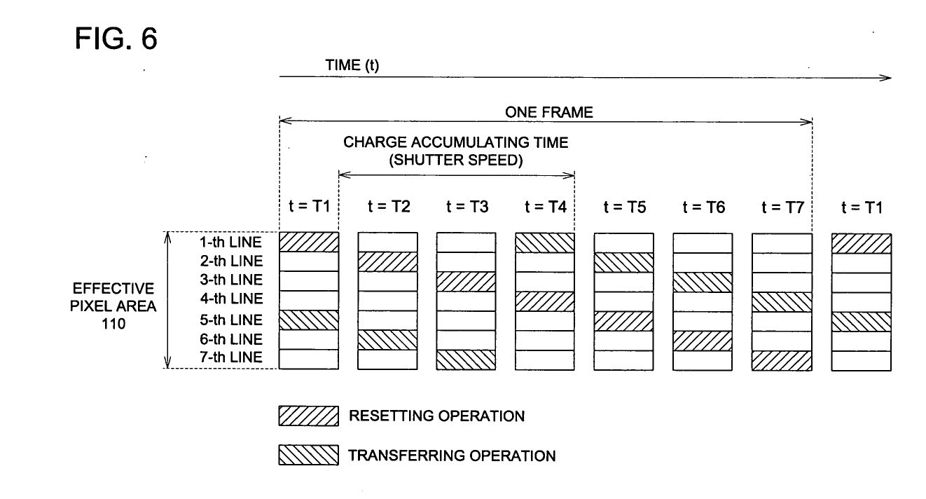

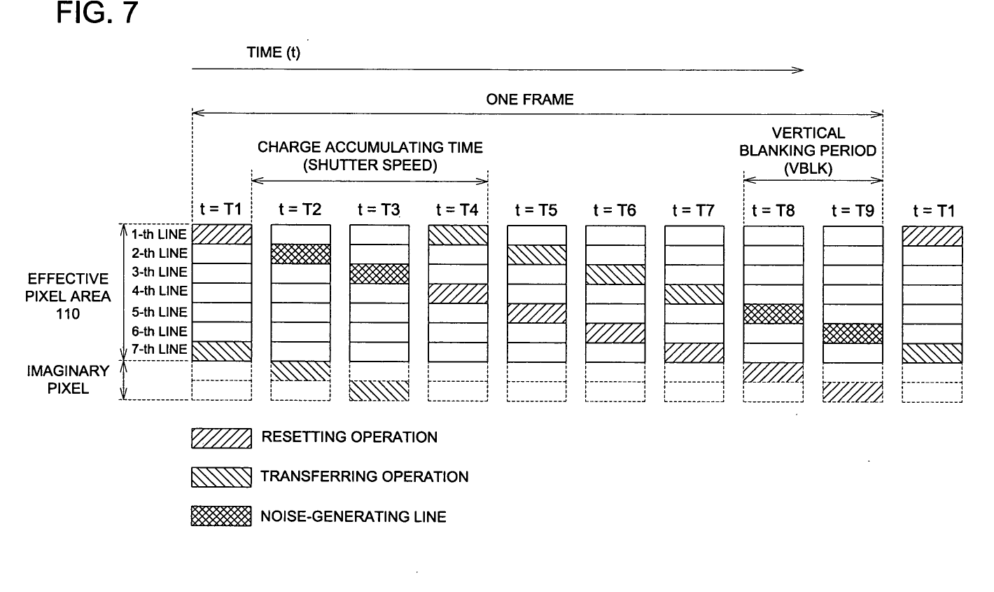

Now, referring to FIG. 6 and FIG. 7, the subject to be solved by the present invention will be detailed in the following. To make the explanation simple, herein, it is assumed that the image sensor 100 shown in FIG. 1 is provided with only the effective pixel area 110 including seven horizontal pixel lines without having the dummy pixel area 112.

FIG. 6 shows a schematic diagram of scanning statuses of the horizontal pixel lines when no vertical blanking period is introduced, namely, when there is no room to cause the problem. On the other hand, FIG. 7 shows another schematic diagram of scanning statuses of the horizontal pixel lines when the vertical blanking period is introduced, namely, when there is a room to cause the problem.

In FIG. 6, it is assumed that, at time t=T1, the first line of the horizontal pixel lines is in a reset operating status to be conducted by the first vertical scanning circuit 101, while the fifth pixel lines is in a transfer operating status for transferring the signal charge stored in the PD section to the FD section to be conducted by the second vertical scanning circuit 102. At this time, the vertical scanning drive circuit 103 drives the two parasitic capacitances included in the first and the fifth horizontal pixel lines as a total load. When the time t progresses to t=T4 after passing through T2 and T3, the horizontal pixel line in the transfer operating status to be conducted by the second vertical scanning circuit 102 returns to the initial first line from the final seventh line. Even at this time, since the vertical scanning drive circuit 103 still drives the two parasitic capacitances included in the first and the fifth horizontal pixel lines as a total load, there is no change in a number of horizontal pixel lines to be loaded by the vertical scanning drive circuit 103. The one frame period continues up to t=T7, and the same operations are repeated thereafter.

Incidentally, paying attention to the first line of the horizontal pixel lines, for instance, a time interval, from time t=T1 when the first line is reset to time t=T4 when the signal charge stored in the PD section is transferred to the FD section, can be defined as a charge storage time, namely, a shutter speed.

Next, as shown in FIG. 7, a vertical blanking period VBLK, including two horizontal pixel lines that follow after the seven horizontal pixel lines included in the effective pixel area, is provided in the image sensor. In other words, the time interval from time t=T1 to time t=T9 can be defined as the one frame period. Assuming that the shutter speed is the same as that indicated in FIG. 6 (from time t=T1 to time t=T4), since the second vertical scanning circuit 102 enters into the vertical blanking period VBLK at time t=T1 and time t=T3, there are no horizontal pixel lines to be scanned by the second vertical scanning circuit 102. Accordingly, the vertical scanning drive circuit 103 drives only one parasitic capacitance included in the second horizontal pixel line or the third horizontal pixel line as a total load.

Namely, the abovementioned fact indicates that the load capacitance to be driven by the vertical scanning drive circuit 103 varies in the time domain. As aforementioned referring to FIG. 3, since the variation of the load capacitance also causes variations of analogue voltages RSB, RX and TX to be fed to each pixel from the vertical scanning drive circuit 103, defects occur in the second line at time t=T2 and in the third line at time t=T3, and concretely speaking, stripe pattern noises are generated on the concerned lines of the image output signal VS. Further, since the first vertical scanning circuit 101 also enters into the vertical blanking period VBLK at time t=T8 and time t=T9, the problem same as the above will arise.

It is needless to say that it is possible to alleviate the influence of such the variation of the load capacitance, by increasing the driving capability of the analogue electric power supply 104 towards the infinitive power. In reality, however, the improvement of the driving capability would be limited due to the dimensional limitation of the circuit size, and further, the variation of the load also causes the variation of analogue voltage due to the wiring resistance, etc. Accordingly, the subject of the present invention cannot be solved by merely improving the driving capability of the analogue electric power supply 104.

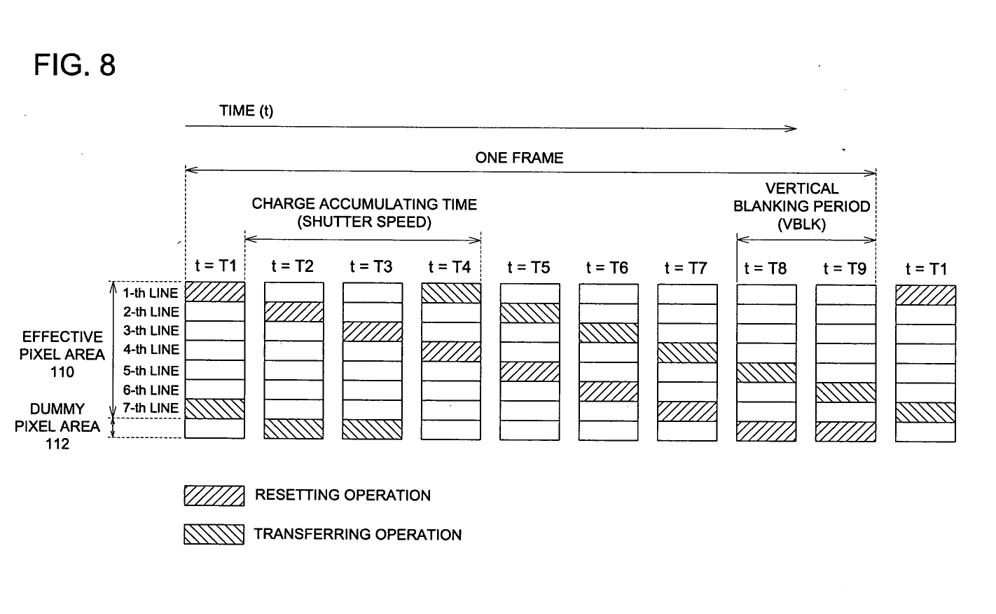

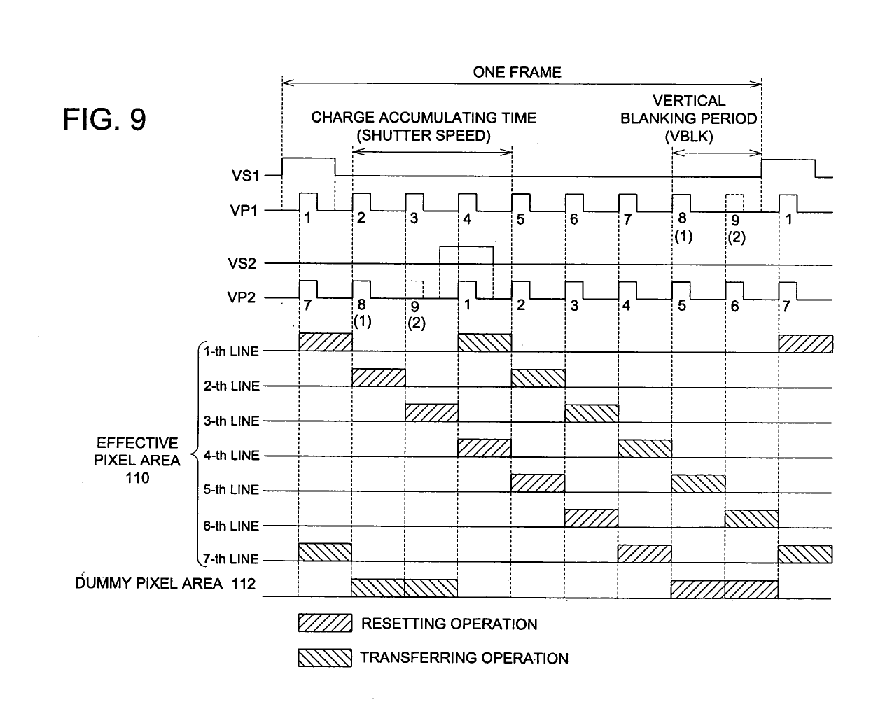

Therefore, the method for preventing the variation of the load to be driven by the vertical scanning drive circuit 103 mentioned in the above will be proposed in the following, referring to FIG. 8 and FIG. 9.

FIG. 8 shows a schematic diagram of scanning statuses of the horizontal pixel lines in the method for preventing the variation of the load to be driven by the vertical scanning drive circuit 103. Opposing to the configuration shown in FIG. 6 and FIG. 7, herein, it is assumed that the image sensor 100 shown in FIG. 1 is provided with both the effective pixel area 110 including seven horizontal pixel lines and the dummy pixel area 112 including one horizontal pixel line.

In the example shown in FIG. 8, the vertical blanking period VBLK, including two horizontal pixel lines that follow after the seven horizontal pixel lines included in the effective pixel area, is also provided in the image sensor, as well as the example shown in FIG. 7. In this example shown in FIG. 8, during the vertical blanking period VBLK from time t=T2 to time t=T3, the second vertical scanning circuit 102 continues the horizontal scanning operation for the dummy pixel area 112, while halts the vertical scanning operation. At this time, the vertical scanning drive circuit 103 scans two horizontal pixel lines, namely, a pair of the second horizontal pixel line and the dummy pixel area 112 or a pair of the third horizontal pixel line and the dummy pixel area 112, as its total load. Accordingly, the variation of the load capacitance does not occur. Even in the time interval from time t=T8 to time t=T9, since the first vertical scanning circuit 101, which enters into the vertical blanking period VBLK, scans the dummy pixel area 112, the variation of the load capacitance does not occur.

Concretely speaking, even when the vertical blanking period VBLK exists and any one of the first and the second vertical scanning circuits need not be operated for acquiring the image signal, the unnecessary one of the vertical scanning circuits is controlled to scan the dummy pixel area, so that the pair of the first and the second vertical scanning circuits always scan the two horizontal pixel lines, respectively. As a result, occurrence of the fluctuation of the load incurred to the vertical scanning drive circuit 103 is effectively prevented.

In other words, when the vertical blanking period VBLK exists, and any one of the first and the second vertical scanning circuits completes the scanning operation for acquiring the image signal, while another one of the vertical scanning circuits continues the scanning operation for acquiring the image signal, a waiting time interval until the scanning-completed one of the vertical scanning circuits enters the next scanning operation, is created (for instance, T8, T9 shown in FIG. 8). Further, when only any one of the first and the second vertical scanning circuits commences the scanning operation for acquiring the image signal before another one of the vertical scanning circuits commences the scanning operation for acquiring the image signal, a waiting time interval until the other one of vertical scanning circuits enters the scanning operation within the concerned frame, is created (for instance, T2, T3 shown in FIG. 8). At such the timing, the concerned one of the vertical scanning circuits is made to scan the dummy pixel area without halting the scanning action of the vertical scanning circuit currently entering in a standby state, so that the pair of the first and the second vertical scanning circuits is controlled to always scan the two horizontal pixel lines, respectively.

FIG. 9 shows a timing chart indicating the scanning statuses of the configuration shown in FIG. 8. In FIG. 9, as shown in FIG. 4 and FIG. 5, the start signal VS1 generated in the timing generator 105 is inputted at first, and then, synchronized with the scanning pulses VP1 from the first pulse (corresponding to time t=T1 shown in FIG. 8, the same in the following) to the seventh pulse (corresponding to time t=T7), the vertical scanning operations are sequentially applied one by one to the horizontal pixel lines from first line to seventh line so as to reset them (indicated by the areas hatched with right-up lines in FIG. 9). At the eighth pulse of the scanning pulses VP1 (corresponding to time t=T8), the dummy pixel area 112 is scanned. At the ninth pulse of the scanning pulses VP1 (corresponding to time t=T9), the supply of the scanning pulses VP1 is halted and no pulse is inputted, while the scanning operation for the dummy pixel area 112 is continued.

Since the vertical blanking period VBLK includes two horizontal pixel lines in the abovementioned example, no pulse is inputted at the timing of the ninth pulse of the scanning pulses VP1 (corresponding to time t=T9). However, when the vertical blanking period VBLK, including “n” horizontal pixel lines, is provided in the image sensor, by halting input of the pulses during a time interval from the timing of the ninth pulse to the timing of the (n−1)-th pulse, it becomes possible to continue to scan the dummy pixel area 112 during the vertical blanking period VBLK including “n” horizontal pixel lines.

In other words, the supplies of both the scanning pulse VP1 to be supplied to the first vertical scanning circuit 101 and the scanning pulse VP2 to be supplied to the second vertical scanning circuit 102 are halted during a time period corresponding to (a number of scanning lines included in the vertical blanking period−1).

On the other hand, the start signal VS2 is inputted at such a timing that the start signal VS2 overlaps the fourth pulse of the scanning pulse VP1, and then, synchronized with the scanning pulses VP2 from the first pulse (corresponding to time t=T4 shown in FIG. 8, the same in the following) to the seventh pulse (corresponding to time t=T1), the vertical scanning operations, serving as the transferring operations, are sequentially applied one by one to the horizontal pixel lines from first line to seventh line (indicated by the areas hatched with right-down lines in FIG. 9). Even at the eighth pulse of the scanning pulses VP2 (corresponding to time t=T2), the dummy pixel area 112 is scanned. At the ninth pulse of the scanning pulses VP2 (corresponding to time t=T3), the supply of the scanning pulses VP2 is halted and no pulse is inputted, while the scanning operation for the dummy pixel area 112 is continued.

As mentioned in the above, the resetting operations and the transferring operations are sequentially repeated, while inserting the time interval corresponding to four scanning pulses between them (namely, the shutter speed). In these operations, since the two horizontal pixel lines are always scanned throughout all of the scanning periods, the variation of the load to be driven by the vertical scanning drive circuit 103 never occur.

As described in the foregoing, since the image sensor 100 is provided with the dummy pixel area 112 to be scanned during the vertical blanking period VBLK, two horizontal pixel lines are always scanned throughout all of the scanning periods. Accordingly, it becomes possible not only to eliminate the variation of the load to be driven by the vertical scanning drive circuit 103, but also to prevent the reproduced image from generating the noises caused by the variation of the load to be driven by the vertical scanning drive circuit 103.

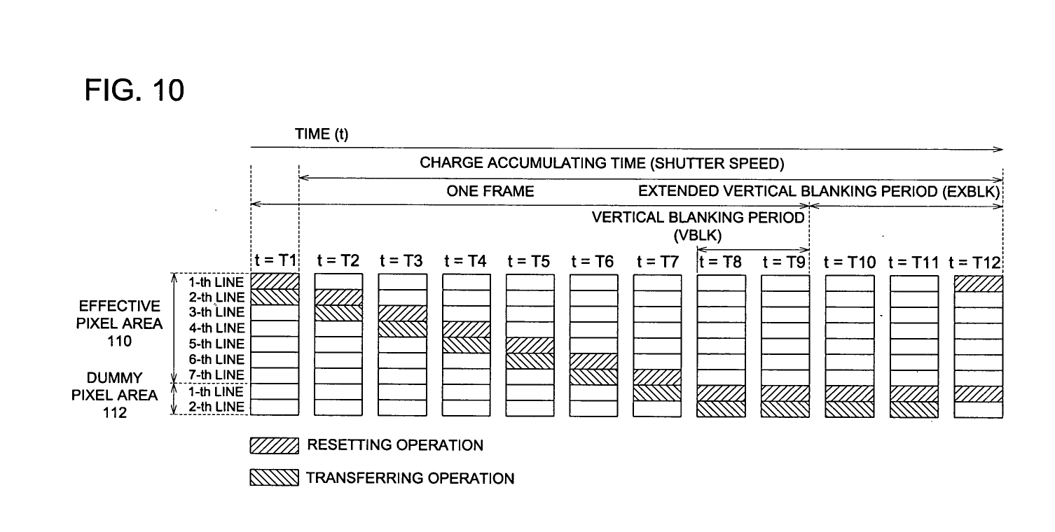

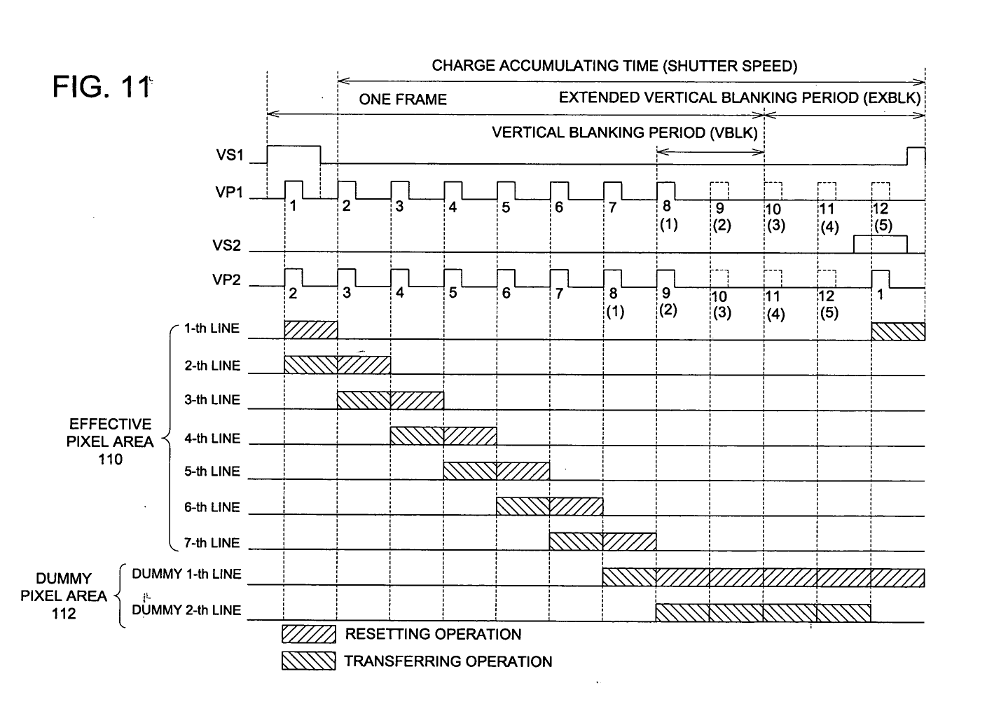

Next, expanding the aforementioned method and referring to FIG. 10 and FIG. 11, a method for realizing a shutter operation of long duration, which exceeds one frame period, will be detailed in the following. FIG. 10 shows a schematic diagram of scanning statuses of the horizontal pixel lines in the method for realizing the shutter operation of long duration, which exceeds one frame period.

Being different from the example shown in FIG. 8, the dummy pixel area 112 includes two dummy lines in the example shown in FIG. 10. This is because, when conducting the shutter operation of long duration, since both the first vertical scanning circuit 101 and the second vertical scanning circuit 102, sometimes, should simultaneously scan the dummy pixel area 112, the first vertical scanning circuit 101 and the second vertical scanning circuit 102 can respectively scan the two dummy lines being independent relative to each other, in order to avoid the variation of the load to be driven by the vertical scanning drive circuit 103.

Herein, it is exemplified in the following to achieve an electric charge storage time (namely, the shutter velocity), which exceeds one frame period (a time for scanning the seven horizontal pixel lines in the effective pixel area+a time for scanning the two dummy lines in the vertical blanking period VBLK), and further includes a time for scanning the three dummy lines (hereinafter, referred to as an extended vertical blanking period EVBLK).

At time t=T1, the first vertical scanning circuit 101 resets the first line in the effective pixel area, while the second vertical scanning circuit 102 transfers the storage charges of the second line in the effective pixel area. During the time interval from time t=T2 to time t=T6, the operations same as the above are repeated by shifting the horizontal pixel line one by one. At time t=T7, the first vertical scanning circuit 101 resets the seventh line in the effective pixel area, while the second vertical scanning circuit 102 scans the first dummy line in the dummy pixel area 112, instead of an effective pixel line in the effective pixel area.

During the time interval from time t=T8 to time t=T11, the first vertical scanning circuit 101 scans the first dummy line in the dummy pixel area 112, while the second vertical scanning circuit 102 scans the second dummy line in the dummy pixel area 112. At time t=T12, the first vertical scanning circuit 101 scans the first dummy line in the dummy pixel area 112, while the second vertical scanning circuit 102 transfers the storage charges of the first line in the effective pixel area.

FIG. 11 shows a timing chart indicating the scanning statuses of the configuration shown in FIG. 10. As well as the configuration shown in FIG. 9, the start signal VS1 generated in the timing generator 105 is inputted at first, and then, synchronized with the scanning pulses VP1 from the first pulse (corresponding to time t=T1 shown in FIG. 10, the same in the following) to the seventh pulse (corresponding to time t=T7), the vertical scanning operations are sequentially applied one by one to the horizontal pixel lines from first line to seventh line so as to reset them (indicated by the areas hatched with right-up lines in FIG. 11). At the eighth pulse of the scanning pulses VP1 (corresponding to time t=T8), the first dummy line in the dummy pixel area 112 is scanned. At timings from the ninth pulse to the twelfth pulse of the scanning pulses VP1 (from time t=T2 to time t=T6), the supply of the scanning pulses VP1 is halted and no pulse is inputted, while the scanning operation for the first dummy line in the dummy pixel area 112 is continued.

On the other hand, the start signal VS2 is inputted at such a timing that the start signal VS2 overlaps the twelfth pulse of the scanning pulse VP1, and then, synchronized with the scanning pulses VP2 from the first pulse (corresponding to time t=T12 shown in FIG. 10, the same in the following) to the seventh pulse (corresponding to time t=T6), the vertical scanning operations, serving as the transferring operations, are sequentially applied one by one to the horizontal pixel lines from first line to seventh line (indicated by the areas hatched with right-down lines in FIG. 11). At the eighth pulse of the scanning pulses VP2 (corresponding to time t=T7), the first dummy line in the dummy pixel area 112 is scanned. At the ninth pulse of the scanning pulses VP2 (corresponding to time t=T8), the second dummy line in the dummy pixel area 112 is scanned. At timings from the tenth pulse to the twelfth pulse of the scanning pulses VP2 (from time t=T2 to time t=T6), the supply of the scanning pulses VP2 is halted and no pulse is inputted, while the scanning operation for the second dummy line in the dummy pixel area 112 is continued.

When the vertical blanking period VBLK, including “n” horizontal pixel lines, is provided in the image sensor, by halting input of the pulses during a time interval from the timing of the ninth pulse to the timing of the (n−1)-th pulse with respect to the scanning pulse VP1, while by halting input of the pulses during a time interval from the timing of the tenth pulse to the timing of the (n−2)-th pulse with respect to the scanning pulse VP2, it becomes possible to continue to scan the dummy pixel area 112 during the vertical blanking period VBLK including “n” horizontal pixel lines.

In other words, the supply of the scanning pulse VP1 to be supplied to the first vertical scanning circuit 101 is halted during a time period corresponding to (a number of scanning lines included in the vertical blanking period−1), while the supply of the scanning pulse VP2 to be supplied to the second vertical scanning circuit 102 is halted during a time period corresponding to (a number of scanning lines included in the vertical blanking period−2).

Incidentally, when a number of dummy lines included in the extended vertical blanking period EVBLK is set at zero, the operations shown in FIG. 10 are the same as those shown in FIG. 8, except that the second dummy line in the dummy pixel area 112 is scanned at the ninth pulse of the scanning pulses VP2.

As indicated in the above, by variably controlling the extended vertical blanking period EVBLK according to the method indicated in FIG. 10 and FIG. 11, it becomes possible not only to realize a shutter operation of long duration, which exceeds one frame period, but also to prevent the reproduced image from generating the noises caused by the variation of the load to be driven by the vertical scanning drive circuit 103.

As described in the foregoing, according to the present invention, in the image capturing unit including the image sensor that is provided with the first vertical scanning circuit and the second vertical scanning circuit, to conduct the line progressive scanning operation, the dummy pixel area is provided in the image sensor, so that, during the time when any one of the first vertical scanning circuit and the second vertical scanning circuit enters in a vertical blanking period, the concerned one of the first vertical scanning circuit and the second vertical scanning circuit scans the dummy pixel area. Accordingly, it becomes possible to provide an image capturing unit, which make it possible to prevent occurrence of noses, such as lateral stripes, etc., in the captured image.

Incidentally, the detailed configurations and operations of the image capturing unit embodied in the present invention can be varied by a skilled person without departing from the spirit and scope of the invention.

While the preferred embodiments of the present invention have been described using specific term, such description is for illustrative purpose only, and it is to be understood that changes and variations may be made without departing from the spirit and scope of the appended claims.

What is claimed is:

1. An image capturing unit, comprising:
an image sensor that is provided with a plurality of pixels, aligned in a two-dimensional matrix pattern, to capture an image of a subject, a first vertical scanning circuit and a second vertical scanning circuit, to conduct a line progressive scanning; and
a control circuit to control a scanning operation of the image sensor;
wherein the image sensor is further provided with a dummy pixel area, and the control circuit controls the scanning operation of the image sensor in such a manner that, when any one of the first vertical scanning circuit and the second vertical scanning circuit enters in a vertical blanking period, the concerned one of the first vertical scanning circuit and the second vertical scanning circuit scans the dummy pixel area.

2. The image capturing unit of claim 1,
wherein the dummy pixel area is fabricated onto at least one of an upper side portion and a lower side portion of the two-dimensional matrix pattern.

3. The image capturing unit of claim 1,
wherein, when any one of the first vertical scanning circuit and the second vertical scanning circuit enters in the vertical blanking period, the control circuit halts an operation for supplying scanning pulses, a number of which is equivalent to {(a number of scanning lines included in the vertical blanking period)−1}, to the concerned one of the first vertical scanning circuit and the second vertical scanning circuit.

4. The image capturing unit of claim 1,
wherein the image sensor is further provided with a vertical scanning drive circuit to drive the plurality of pixels by supplying an analogue voltage.

5. The image capturing unit of claim 4,
wherein the vertical scanning drive circuit applies a predetermined voltage onto a gate of a transferring transistor included in each of the plurality of pixels, during an image capturing operation of the plurality of pixels.

6. The image capturing unit of claim 4,
wherein the vertical scanning drive circuit applies a predetermined voltage onto a gate of a resetting transistor included in each of the plurality of pixels, during an image capturing operation of the plurality of pixels.

7. An image capturing unit, comprising:
an image sensor that is provided with a plurality of pixels, aligned in a two-dimensional matrix pattern, to capture an image of a subject, a first vertical scanning circuit and a second vertical scanning circuit, to conduct a line progressive scanning operation; and
a control circuit to control a scanning operation of the image sensor;
wherein, even if a vertical blanking period exists in the line progressive scanning operation, the control circuit controls the scanning operation of the image sensor in such a manner that any one of the first vertical scanning circuit and the second vertical scanning circuit is made to scan a specific horizontal pixel line including elements, which are not to be used for forming a reproduced image of the image, at a predetermined timing, so that a pair of the first vertical scanning circuit and the second vertical scanning circuit always scans two horizontal pixel lines residing in the two-dimensional matrix pattern, respectively.

8. The image capturing unit of claim 7,
wherein the predetermined timing is defined as a time when any one of the first vertical scanning circuit and the second vertical scanning circuit is made to scan a horizontal pixel line, which is currently used for capturing the image, while another one of them need not scan any horizontal pixel line used for capturing the image.

9. The image capturing unit of claim 7,
wherein the predetermined timing is defined as a time period residing between a frame and a next frame, in which any one of the first vertical scanning circuit and the second vertical scanning circuit is made to scan a horizontal pixel line, which is currently used for capturing the image, while another one of them is waiting in a standby state until the other one of them commences to scan a horizontal pixel line used for capturing the image.

10. The image capturing unit of claim 7,
wherein, when any one of the first vertical scanning circuit and the second vertical scanning circuit enters in the vertical blanking period, the control circuit halts an operation for supplying scanning pulses, a number of which is equivalent to {(a number of scanning lines included in the vertical blanking period)−1}, to the concerned one of the first vertical scanning circuit and the second vertical scanning circuit.

11. The image capturing unit of claim 7,
wherein each of the elements, which are not to be used for forming the reproduced image of the image, serves as a electric load having substantially a same property as that of each of the plurality of pixels.

12. The image capturing unit of claim 7,
wherein the elements, which are not to be used for forming the reproduced image of the image, are dummy pixels.

13. The image capturing unit of claim 12,
wherein the dummy pixels are fabricated onto at least one of an upper side portion and a lower side portion of the two-dimensional matrix pattern.

14. The image capturing unit of claim 7,
wherein a configuration of each of the elements, which are not to be used for forming the reproduced image of the image, is substantially a same as that of each of the plurality of pixels.

15. A method for capturing an image, comprising:
capturing an image of a subject by employing an image sensor that is provided with a plurality of pixels, aligned in a two-dimensional matrix pattern, a first vertical scanning circuit and a second vertical scanning circuit, to conduct a line progressive scanning operation; and
controlling a scanning operation of the image sensor;
wherein, even if a vertical blanking period exists in the line progressive scanning operation, the scanning operation of the image sensor is controlled in such a manner that any one of the first vertical scanning circuit and the second vertical scanning circuit is made to scan a specific horizontal pixel line including elements, which are not to be used for forming a reproduced image of the image, at a predetermined timing, so that a pair of the first vertical scanning circuit and the second vertical scanning circuit always scans two horizontal pixel lines residing in the two-dimensional matrix pattern, respectively.

16. The method of claim 15,
wherein the predetermined timing is defined as a time when any one of the first vertical scanning circuit and the second vertical scanning circuit is made to scan a horizontal pixel line, which is currently used for capturing the image, while another one of them need not scan any horizontal pixel line used for capturing the image.

17. The method of claim 15,
wherein the predetermined timing is defined as a time period residing between a frame and a next frame, in which any one of the first vertical scanning circuit and the second vertical scanning circuit is made to scan a horizontal pixel line, which is currently used for capturing the image, while another one of them is waiting in a standby state until the other one of them commences to scan a horizontal pixel line used for capturing the image.
